(19) United States
(12) Patent Application Publication
(10) Pub. No.: US 2026/0065636 A1
(43) Pub. Date: Mar. 5, 2026

(54) Article Recognition System and Method

(71) Applicant: FLYTECH TECHNOLOGY CO., LTD., Taipei City (TW)

(72) Inventor: Cheng-Tien HSIEH, Taipei City (TW)

(21) Appl. No.: 18/944,221

(22) Filed: Nov. 12, 2024

(30) Foreign Application Priority Data
Aug. 28, 2024 (TW) 113132397

(51) Int. Cl. G06V 10/74; G06V 10/22; G06V 10/40; G06V 10/75; G06V 10/774; G06V 20/68

(52) U.S. Cl. CPC G06V 10/761; G06V 10/225; G06V 10/40; G06V 10/7515; G06V 10/774; G06V 20/68; G06V 2201/07

(57) ABSTRACT

The present invention relates to an article recognition method. The method includes of executing a first feature extraction programming module to extract a plurality of candidate article feature vectors from a plurality of candidate article images; executing a second feature extraction programming module and an image registration transformation programming unit to perform an image registration on a target article image and extract a target article feature vector therefrom; and executing a discrepancy determination programming module to compare the target article feature vector with each of the plurality of candidate article feature vectors and generate a similarity score accordingly.

### CROSS-REFERENCE TO RELATED APPLICATION

This application claims priority benefit to Taiwan Invention Patent Application Serial No. 113132397, filed on Aug. 28, 2024, in Taiwan Intellectual Property Office, the entire disclosures of which are incorporated by reference herein.

### FIELD

The present invention relates to an article recognition system and method, in particular, an article recognition system and method in which the article detection process, the feature extraction process, and the discrepancy determination process are performed separately in different phases, and the same feature extraction model is used in both the preparation phase and the feature extraction phase.

### BACKGROUND

In modern society, self-service and self-checkout technologies, which enable cashier-less checkout, have gradually become widespread and are beginning to replace traditional manual checkout systems. These technologies offer significant benefits such as reducing labour costs, speeding up the checkout process and lowering operating costs, rendering them particularly attractive to the retail and service industries. However, as self-service and self-checkout technologies become more widespread and in demand, the limitations of conventional self-checkout technology are becoming more apparent, particularly in the area of article recognition, where numerous challenges remain.

In particular, the article recognition technology employed by conventional self-checkout systems faces many limitations in identifying a wide variety of massive products. For example, traditional article recognition methods typically rely on large amounts of pre-labelled data to train neural networks for learning and recognition purposes.

For retailers, however, the frequent changes in the products displayed on store shelves are quite a challenge. Each time the inventory changes, it is necessary to reorganize and re-label the samples, including taking numerous images of new products and re-labelling them for model learning. For products that are removed from the shelves, their attributes must be changed to “don't care” status, requiring retraining of the neural network and possibly modifications to the program. These operations are not only impractical for self-checkout or point-of-sale (POS) systems, but also result in a decrease in recognition accuracy.

To address the above shortcomings, there is an urgent need for article recognition technology capable of rapidly learning and accurately identifying a wide variety of massive products. The technology is supposed to be highly flexible and adaptable to accommodate the frequent changes in products on store shelves, while maintaining a high level of recognition accuracy, thereby providing a more viable technical solution for self-service and self-checkout systems.

Hence, there is a need to solve the above deficiencies/issues.

### SUMMARY

The present invention relates to an article recognition system and method, in particular, an article recognition system and method in which the article detection process, the feature extraction process, and the discrepancy determination process are performed separately in different phases, and the same feature extraction model is used in both the preparation phase and the feature extraction phase.

The present invention provides an article recognition method. The method includes: executing a first feature extraction programming module to extract a plurality of candidate article feature vectors from a plurality of candidate article images; executing a second feature extraction programming module and an image registration transformation programming unit to perform an image registration on a target article image and extract a target article feature vector therefrom; and executing a discrepancy determination programming module to compare the target article feature vector with each of the plurality of candidate article feature vectors and generate a similarity score accordingly.

The present invention further provides an article recognition method. The method includes: implementing a preparation phase to execute a shared feature extraction programming module to extract a plurality of candidate article feature vectors from a plurality of candidate article images; implementing an article detection phase to detect a target article in a target article image and marking the target article in the target article image with an article box; implementing a shared feature extraction phase to execute the shared feature extraction programming module and an image registration transformation programming unit to perform an image registration on an image contained within the article box and extract a target article feature vector accordingly; and implementing a discrepancy determination phase to compare the target article feature vector with the plurality of candidate article feature vectors and generate a plurality of similarity score accordingly.

The present invention further provides an article recognition system. The system includes: a database configured to store a plurality of candidate article feature vectors extracted by executing a first feature extraction programming module; an image sensor configured to capture a target article image for a target article; and a server configured to implement an article recognition method, the article recognition method including: executing an article detection programming module to detect the target article in the target article image and marking the target article in the target article image with an article box; executing a second feature extraction programming module and an image registration transformation programming unit to perform an image registration on an image contained within the article box and extract a target article feature vector accordingly; and executing a discrepancy determination programming module to compare the target article feature vector with the plurality of candidate article feature vectors and generate a similarity score accordingly.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating the system architecture for the article recognition system according to the present invention;

FIG. 2 is a block based schematic diagram illustrating the article recognition method and the execution phases it contains;

FIG. 3 is a block based schematic diagram illustrating the article recognition programming model and the programming modules it contains;

FIG. 4 is a schematic diagram illustrating the movement path for the spanning tree according to the present invention;

FIGS. 4 and 5 are schematic diagrams illustrating the first embodiment according to the present invention;

FIG. 6 is a schematic diagram illustrating a second embodiment according to the present invention;

FIGS. 7, 8, and 9 are schematic diagrams illustrating a third embodiment according to the present invention;

FIG. 10 is a block based schematic diagram illustrating the local feature description method included in the fourth embodiment according to the present invention;

FIG. 11 is a block based schematic diagram illustrating the deep neural network included in the fourth embodiment according to the present invention;

FIG. 12 is a block based schematic diagram illustrating the domain adversarial neural network included in the fifth embodiment according to the present invention;

FIG. 13 is a block based schematic diagram illustrating the training method for the domain adversarial neural network in the fifth embodiment according to the present invention; and

FIG. 14 is a flow chart showing the implementation steps involved in the article recognition method according to the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including,” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

Traditional object or item recognition technologies applying deep learning require training neural networks with a large amount of labeled image data, in order to help the neural network learn how to recognize specific articles. However, for retailers, especially medium and large-scale stores, the products on the shelves change frequently. Each time the products on the shelves are changed, numerous sample images of newly added products must be filmed and re-labeled to retrain the neural network. As for products that are removed from the shelves, the corresponding sample images must be removed from the database or have their attributes changed to “don't care”. The process not only involves extensive works for data preprocessing and the neural network retraining, but may also require modifications to the program structure. Therefore, the use of traditional article recognition technologies for self-checkout systems or POS machines is apparently impractical. The present invention proposes an improved article recognition system and method, preferably applicable to, but not limited to, self-checkout systems or POS machines. It is designed to operate with minimal learning data or light training, enabling rapid deployment for on-line product recognition.

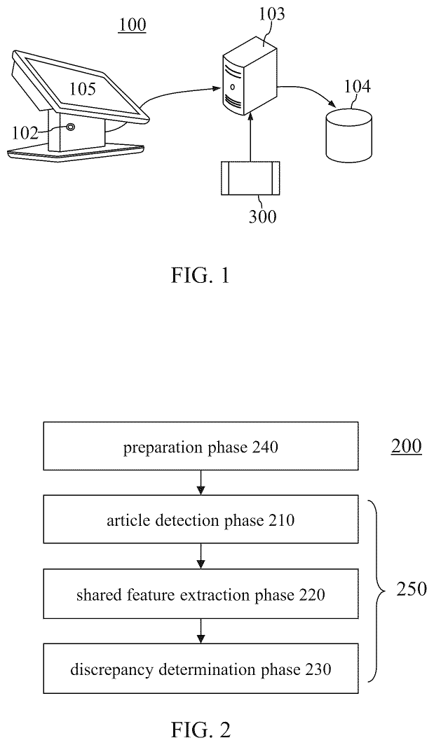

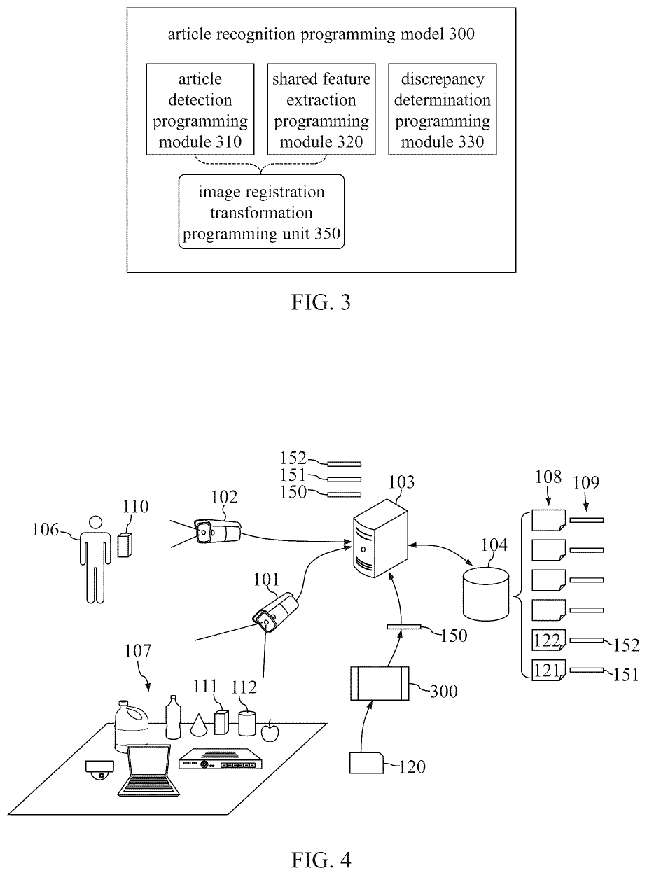

FIG. 1 is a schematic diagram illustrating the system architecture for the article recognition system according to the present invention. FIG. 2 is a block based schematic diagram illustrating the article recognition method and the execution phases it contains. FIG. 3 is a block based schematic diagram illustrating the article recognition programming model and the programming modules it contains. The article recognition method 200 proposed by the present invention is preferably implemented on the article recognition system 100 in the form of the article recognition programming model 300.

The article recognition system 100 according to the present invention includes image sensors 101 and 102, a server 103, a database 104, and an article recognition programming model 300. The article recognition programming model 300 is preferably installed on the server 103 for execution. The image sensor 102 is preferably attached to a checkout management device 105, which is preferably a self-service terminal (SST), a self-checkout (SCO) machine, a point-of-sale (POS) machine, or a cash register.

In order to quickly recognize various articles with different structures, shapes, and appearance features, the present invention proposes an article recognition method 200. The article recognition method 200 includes an article detection phase 210, a shared feature extraction phase 220, and a discrepancy determination phase 230. Prior to implementing the article recognition method 200, a selective preparation phase 240 is selectively performed.

Preferably, the article recognition method 200 is implemented via executing an article recognition programming model 300. The article recognition programming model 300 includes an article detection programming module 310, a shared feature extraction programming module (the first feature extraction programming module and the second feature extraction programming module) 320, and a discrepancy determination programming module 330. The article recognition programming model 300 is configured to perform the article recognition method 200.

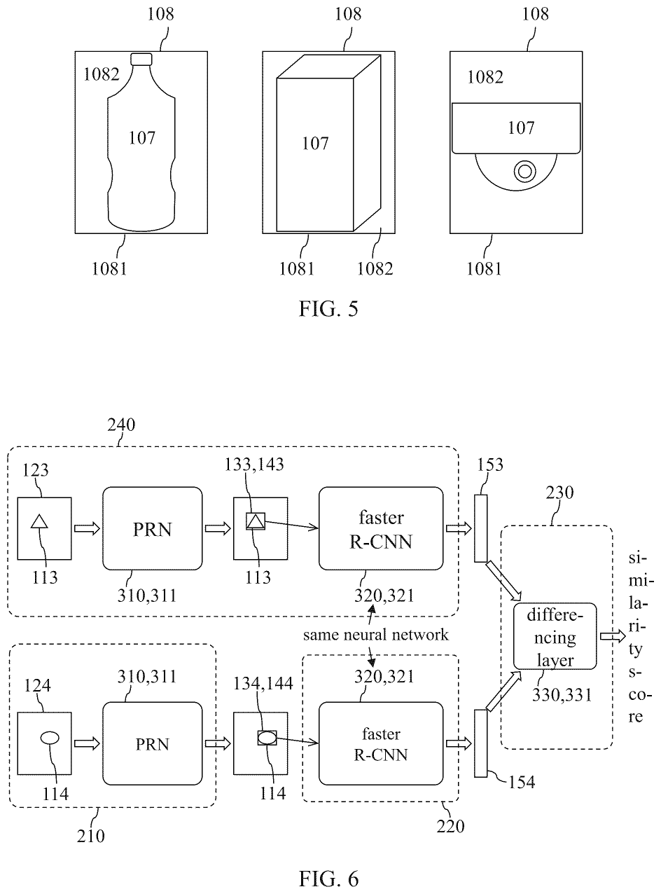

FIGS. 4 and 5 are schematic diagrams illustrating the first embodiment according to the present invention. In this embodiment, the candidate articles 107 are preferably various items prepared for sale. For example, in a supermarket, the candidate articles 107 may include a wide range of products, from fruits and vegetables to canned goods, beverages, and various 3C products. Different products not only have varying shapes and appearances, but also varying colors and patterns. These candidate articles 107 include the first candidate article 111 and the second candidate article 112.

When these candidate articles 107 are prepared for sale on supermarket shelves, traditional article recognition techniques require filming numerous sample images for each candidate articles 107, followed by manually labeling each sample images for the recognition model to learn, which is a labor-intensive process. The process not only requires retraining of the article recognition model but also involves program modifications, which consume significant time and resources, and easily introduce a risk of error. The article recognition method 200 proposed in the present invention is capable of overcoming these shortcomings.

Firstly, in the preparation phase 240, a first preparation method is selectively implemented. The image sensor 101 is used to film a candidate article image 108 for each candidate article 107. Preferably, each candidate article image 108 may contain the image of one or more candidate articles 107, including the first candidate article image 121 and the second candidate article image 122, which are filmed for the first candidate article 111 and the second candidate article 112, respectively. Then, for each candidate article image 108, the edges of each candidate article 107 are labeled in the form of a rectangular box on the candidate article image 108.

Next, the article detection programming module 310 is trained by using the candidate article images 108 labeled with a rectangular box to enable the article detection programming module 310 to have the capability to detect candidate articles 107 from any image and to mark the detected candidate articles 107 in the form of an article box out of from the image. The article box has the position, width, and height representing the position, width, and height for the detected candidate articles 107, respectively.

Next, the shared feature extraction programming module 320 is then executed. The shared feature extraction programming module 320 is configured to read the labeled candidate article images 108 and extract the candidate article feature vectors 109 from the image enclosed by the article box in the labeled candidate article images 108. All of the extracted candidate article feature vectors 109, along with the candidate article images 108, are stored in the database 104. These candidate article feature vectors 109 include the first candidate article feature vector 151 from the first candidate article image 121 and the second candidate article feature vector 152 from the second candidate article image 122.

Preferably, in the preparation phase 240, a second preparation method is also selectively implemented. When the image sensor 101 is used to film a candidate article image 108 for each candidate article 107, it is preferable to ensure that all candidate articles 107 occupy as much of the candidate article image 108 as possible, and the image preferably has the background 1082 in a monochromatic background.

For example, as illustrated in FIG. 5, in each candidate article image 108, the candidate article 107 fills as much of the image area defined by the image boundary 1081 as possible to occupy the entire candidate article image 108. The background is filled with, for example, but not limited to, green color. Since the background of the candidate article image 108 already has a uniform monochromatic background, it is not necessary to additionally mark the candidate article 107 with a rectangular box. In this respect, the entire content of the candidate article image 108 is considered to be the image within the rectangular box.

Preferably, in the preparation phase 240, a third preparation method is selectively implemented. The third method involves filming multiple target article images from different angles of view for the same candidate article 107, in order to generate multiple sets of candidate article feature vectors 109 representing the same candidate article 107, which are then stored in the database 104.

In one embodiment, in the checkout phase 250, when a consumer 106 takes a target article 110 and initiates a self-checkout process, the image sensor 102 is triggered to track the target article 110 and film a target article image 120 for the target article 110. After the image sensor 102 films the target article image 120, the implementation of the article recognition method 200 is automatically triggered.

Once the article recognition method 200 is initiated to implement, the article detection phase 210 is executed first. The implementation of the article detection phase 210 includes executing the article detection programming module 310. Once the article detection programming module 310 is executed, it begins to automatically detect the correct position of the target article 110 in the target article image 120 and then marks the target article 110 in the target article image 120 using an article box.

Next, the shared feature extraction phase 220 is then implemented. The implementation of the shared feature extraction phase 220 includes executing the shared feature extraction programming module 320. Once the shared feature extraction programming module 320 is executed, it begins to extract the target article feature vector 150 from the target article image 120 including the target article 110 that is enclosed within the article box.

Next, the discrepancy determination phase 230 is then implemented. The implementation of the discrepancy determination phase 230 includes executing the discrepancy determination programming module 330. Once the discrepancy determination phase 230 is executed, it is configured to compare the target article feature vector 150, one at a time, with all of the candidate article feature vectors 109, including the first candidate article feature vector 151 and the second candidate article feature vector 152, stored in the database 104. In one embodiment, when the comparison with the first candidate article feature vector 151 indicates that the similarity score between the target article feature vector 150 and the first candidate article feature vector 151 is greater than a certain threshold value, then the article recognition programming model 300 confirms that the articles contained in the target article image 120 and the first candidate article image 112 have a very high similarity, and accordingly determines that the target article 110 contained in the target article image 120 is the first candidate article 111. The threshold value is preferably 0.95, 0.96, 0.97, 0.98, or 0.99, but is not limited thereto.

The article detection programming module 310 is preferably a model selected from boundary box detection models, anchor box detection models, edge box detection models, sliding window detection models, region proposal detection models, region proposal network (RPN) detection models, feature pyramid network (FPN) detection models, region-based convolutional neural network (R-CNN) detection models, fast R-CNN detection models, faster R-CNN detection models, mask R-CNN detection models, Cascade R-CNN detection models, Cascade mask R-CNN detection models, YOLO detection models, Single Shot MultiBox Detector (SSD) method, RetinaNet detection models, EfficientDet detection models, fully convolutional one-phase detection (FCOS) models, object localization detection models, landmark detection models, non-max suppression detection models, or maximally stable extremal region (MSER) detection models.

The shared feature extraction programming module 320 is preferably a feature extraction model selected from convolutional neural network (CNN) feature extraction models, region-based convolutional neural network (R-CNN) feature extraction models, fast R-CNN feature extraction models, faster R-CNN feature extraction models, mask R-CNN feature extraction models, Cascade R-CNN feature extraction models, Cascade mask R-CNN feature extraction models, Light-head R-CNN feature extraction models, fully convolutional neural network (FCNN) feature extraction models, region-based FCNN feature extraction models, fully-connected neural network (FCNN) feature extraction models, recurrent neural network (RNN) feature extraction models, Scale-Invariant Feature Transform (SIFT) feature extraction models, Speeded-Up Robust Features (SURF) feature extraction models, Oriented FAST and Rotated BRIEF (ORB) feature extraction models, Histogram of Oriented Gradients (HOG) feature extraction models, Local Binary Patterns (LBP) feature extraction models, Principal Component Analysis (PCA) feature extraction models, Gabor filter feature extraction models, AutoEncoder feature extraction models, attention mechanism feature extraction models, self-attention mechanism feature extraction models, capsule neural networks, Vision Transformer feature extraction models, graph neural networks, Generative Adversarial Networks (GANs) feature extraction models, or multimodal fusion feature extraction models.

The discrepancy determination programming module 330 is preferably a discrepancy determination model selected from differencing layer models, residual network (ResNet) models, Inception network models, EfficientNet models, Visual Geometry Group (VGG) models, cosine similarity models, Euclidean distance models, correlation coefficient models, Gaussian kernel function models, Jaccard similarity models, Pearson correlation coefficient models, or mutual information models.

FIG. 6 is a schematic diagram illustrating a second embodiment according to the present invention. In this embodiment, a faster region-based convolutional neural network (faster R-CNN) feature extraction model, including but not limited to, is preferably employed to establish candidate article feature vectors 109 for each candidate article in the preparation phase 240. The article detection programming module 310 executed during the article detection phase 210 is preferably, but not limited to, a region proposal network detection model. The shared feature extraction programming module 320 executed during the shared feature extraction phase 220 is preferably, but not limited to, a faster R-CNN feature extraction model. The discrepancy determination programming module 330 executed during the discrepancy determination phase 230 is preferably, but not limited to, a differencing layer discrepancy determination model 331.

In this embodiment, the faster R-CNN feature extraction model used by the shared feature extraction programming module 320 during the checkout phase 250 has the same parameters and weights as the one used during the preparation phase 240.

In this embodiment, in the preparation phase 240, the article detection programming module 310 is configured to execute the region proposal network detection model 311 to identify potential regions containing the third candidate article 113 in the third candidate article image 123 and to mark these potential regions with a third candidate article box 133. The third candidate article box 133 includes the third candidate article box image 143.

However, in the preparation phase 240, the article detection programming module 310 may selectively implement a second preparation method. When capturing the third candidate article image 123 for the third candidate article 113, the third candidate article 113 is made to fill as much of the captured candidate article image 123 as possible. A monochromatic background is used in the candidate article image 123. As a result, it is not necessary to mark the potential regions containing the third candidate article 113 with the third candidate article box 133.

Next, the shared feature extraction programming module 320 is configured to execute the faster R-CNN feature extraction model 321 to extract the third candidate article feature vector 153 from the third candidate article box image 143. The third candidate article feature vector 153 is then stored in the database 104 for later retrieval.

In this embodiment, in the actual checkout phase 250, after the article recognition method 200 is implemented, the article detection phase 210 is first implemented. In the article detection phase 210, the article detection programming module 310 is configured to execute the region proposal network detection model 311, so as to identify potential regions containing the fourth article 114 in the fourth article image 124 including the fourth article 114 and to mark these potential regions with a fourth article box 134 in the fourth article image 124. The fourth article box 134 includes the fourth article box image 144.

Next, the shared feature extraction phase 220 is implemented. In the shared feature extraction phase 220, the shared feature extraction programming module 320 is configured to execute the faster R-CNN feature extraction model 321 to extract the fourth article feature vector 154 from the fourth article box image 144.

Next, the discrepancy determination phase 230 is implemented. In the discrepancy determination phase 230, the discrepancy determination programming module 330 is configured to execute the differencing layer discrepancy determination model 331, retrieve the third candidate article feature vector 153 from the database 104, and compare it to the fourth article feature vector 154 by inputting both vectors into the differencing layer. The differencing layer finally outputs a similarity score between 0 and 1. If the similarity score exceeds a certain threshold value, such as 0.95, the article recognition programming model 300 confirms that the third candidate article image 121 and the fourth article image 131 contain highly similar articles accordingly, thereby recognizing that the fourth article 114 is the same as the third candidate article 113 and identifying both as the same product or item.

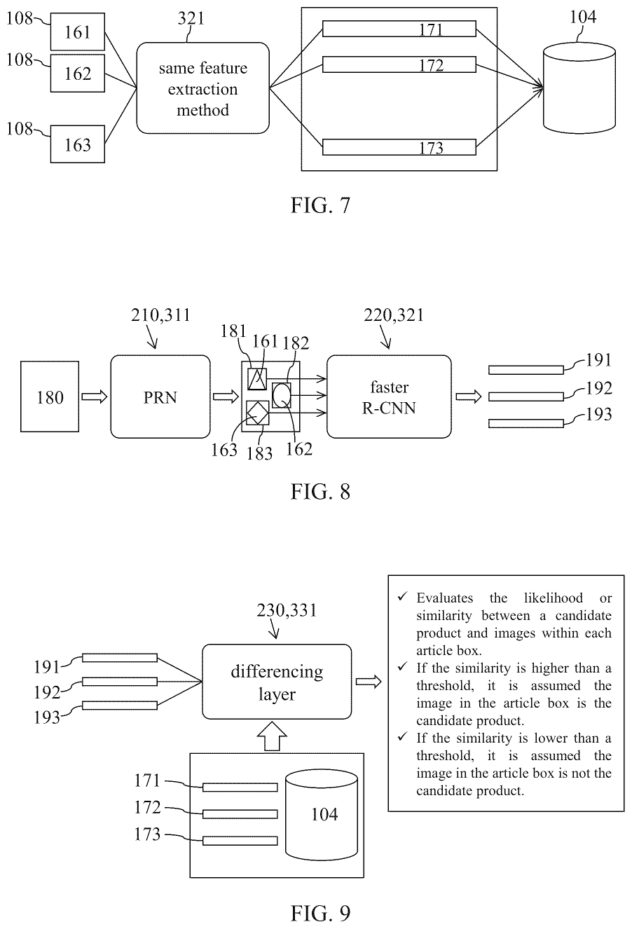

FIGS. 7, 8, and 9 are schematic diagrams illustrating a third embodiment according to the present invention. In this embodiment, in the preparation phase 240, first requires filming and organizing all of the goods and items that are currently on sale on the shelves, including but not limited to, the first article 161, second article 162, and third article 163. The second preparation method is selected, for example, but not limited to, to generate the candidate article images 108, and then the same faster R-CNN feature extraction model 321 executed in the shared feature detection phase 220, is applied to convert all items, including the first article 161, second article 162, and third article 163, into their respective feature vectors: the first article feature vector 171, the second article feature vector 172, and the third article feature vector 173, which are then stored in the database 104 to create a complete dataset of feature vectors for all items on sale for later retrieval by the article recognition programming model 300.

In one embodiment, in the actual checkout phase 250, in a single image 180 captured by the image sensor 102 on the checkout management device 105, it may include one or more articles, such as the first article 161, the second article 162, and the third article 163, at the same time. Therefore, the region proposal network detection model 311 executed during the article detection phase 210 is configured to mark multiple article boxes 181-183 in the image 180. The position, width, and height of each article box 181-183 preferably represent the position, width, and height of the corresponding articles.

Next, the faster R-CNN feature extraction model 321 executed in the shared feature detection phase 220 is preferably configured to extract the images contained within all of the article boxes 181-183 in the image 180, and then input these images into the same faster R-CNN feature extraction method used in the preparation phase 240, so as to convert the images within the article boxes 181-183 into their corresponding feature vectors 191-193.

Eventually, the differencing layer discrepancy determination model 331 executed in the discrepancy determination phase 230 is preferably configured to sequentially compare each feature vector 191-193 with the first article feature vector 171, the second article feature vector 172, and the third article feature vector 173, which respectively represent specific items and are pre-stored in the database 104. After the comparison for all of the feature vectors 191-193 is complete, the system is able to successfully identify the items contained in the article boxes 181-183. For example, the feature vectors 191-193 extracted from the article boxes 181-183 are successfully identified as first article 161, second article 162 and third article 163 respectively.

In one embodiment, the appearance or outer packaging of some articles may have significant variations when viewed from different angles of view. If only a single image is recorded for each article when creating the article image database, in an actual checkout scenario, articles to be checked out and facing the image sensor 102 may be placed at arbitrary angles of view, which causes the article recognition programming model 300 to have difficulty accurately identifying articles placed at arbitrary angles of view.

To address the above issue, in one embodiment, during the creation of the article image database or in the preparation phase 240, multiple article images are recorded from different angles of view for the same article, to create multiple sets of article feature vectors representing the same article.

The approach is particularly effective for articles with significant differences in front and back packaging, and even for some articles with a polyhedral shape where the appearance of each face differs significantly. By the approach of generating multiple angles of view images and creating multiple sets of article feature vectors, it effectively solves the problem of recognizing articles from arbitrary angles of view, thereby improving recognition accuracy and success rates in real-world applications.

In one embodiment, the third candidate article image 123 filmed during the preparation phase 240 and the fourth article image 124 filmed during the checkout phase 250 may have varying degrees of geometric distortion due to factors such as different camera angles, camera displacement, lens distortion, and differences in ambient lighting. However, the two images are still correlated and include the same article. In such cases, appropriate image registration between the two images is required to correctly identify the article contained in the fourth article image 124. To better address this issue, the present invention further proposes a fourth embodiment.

In general, when the image sensor captures a two-dimensional image in three-dimensional space, the spatial coordinate transformations involved may include, but are not limited to, translation, rotation, scaling, skewing, projection, affine transformation and similarity transformation.

In the fourth embodiment, in the preparation phase 240, when creating the candidate article image database, it is necessary to store not only the candidate article feature vectors 109 but also the original third candidate article image 123 in the database 104.

In the article detection phase 210, the filmed fourth article image 124 may easily have varying degrees of geometric distortion with respect to the third candidate article image 123 due to factors such as different camera angles, camera displacement, lens distortion, and differences in ambient lighting. Although the article detection programming module 310 is still able to generate the fourth article box 134 and label a candidate region in the fourth article image 124 that may contain the fourth article 114, the calculated fourth article feature vector 154 may have significant discrepancies with the third candidate article feature vector 153, resulting in recognition being impossible. Therefore, the fourth article image 124 is required to be appropriately and properly corrected to render the fourth article image 124 to be aligned with the third candidate article image 123.

The article detection programming module 310 is preferably configured to selectively integrate an image registration transformation programming unit 350 therein. The article detection programming module 310 is configured to implement the image registration transformation programming unit 350. The image registration transformation programming unit 350 is configured to perform an image registration transformation method to find a transformation matrix Y that is capable of rendering the fourth article image 124 to be aligned with the third candidate article image 123.

The image registration transformation method may include, but is not limited to, the local feature description method or deep neural networks, wherein the local feature description method may further include, but is not limited to: the scale-invariant feature transform (SIFT) method, the speeded up robust feature (SURF) method, orientated FAST and robust BRIEF (ORB) method, the binary robust independent elementary features (BRIEF) method, the fast retina keypoint (FREAK) method, and the histogram of oriented gradients (HOG) method.

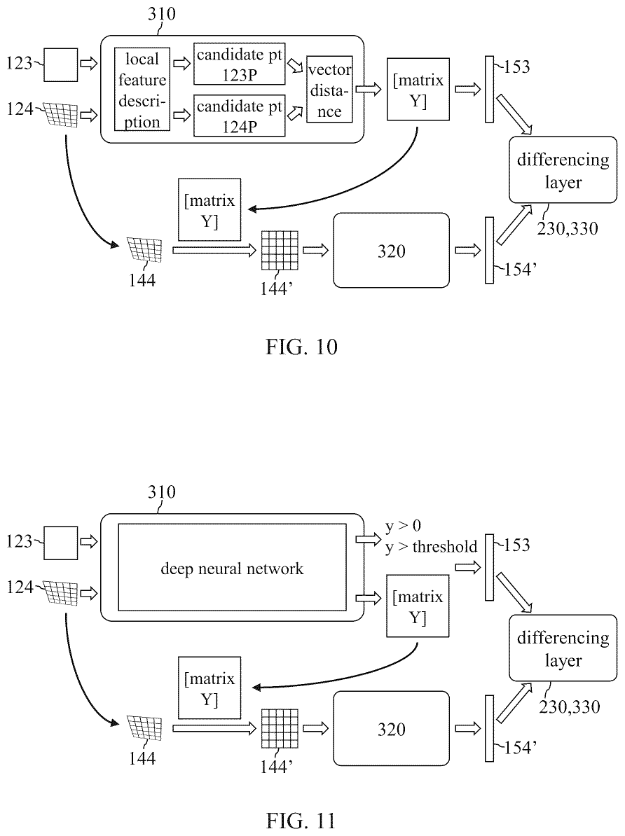

FIG. 10 is a block based schematic diagram illustrating the local feature description method included in the fourth embodiment according to the present invention. In this embodiment, the local feature description method is used as an example. The article detection programming module 310 is configured to perform the local feature description method, to extract multiple candidate points 124P from the fourth article image 124, wherein the candidate points 124P are preferably, but not limited to, corner points, and to transform the image around these candidate points 124P into multiple feature vectors. Similarly, the article detection programming module 310 is also configured to extract multiple candidate points 123P from the third candidate article image 123 and to transform the image around these candidate points 123P into multiple feature vectors.

Next, the article detection programming module 310 is configured to compute and compare the vector distances between the multiple feature vectors for the fourth article image 124 and the multiple feature vectors for the third candidate article image 123. If a vector distance smaller than a predetermined threshold is found, it indicates the presence of a homography relationship between a particular candidate point 124P and a particular candidate point 123P, whereby the candidate point 124P and the candidate point 123P can be used as registration points. When the number of registration points is sufficiently large, i.e., greater than a certain threshold, and has been collected, methods such as, but not limited to, the random sample consensus (RANSAC) method can be applied to compute and find the transformation matrix Y. Through the transformation matrix Y, the fourth article image 124 can be aligned or mapped to the third candidate article image 123.

After the transformation matrix Y is calculated and generated, the article detection programming module 310 is configured to align and register the fourth article box image 144 contained in the fourth article box 134 with the third candidate article image 123 through the transformation matrix Y, and to generate the aligned fourth article box image 144′.

In the shared feature detection phase 220, the shared feature extraction programming module 320 is executed to extract the aligned fourth article feature vector 154′ from the aligned fourth article box image 144′. The discrepancy determination phase 230 is then performed to execute the discrepancy determination programming module 330 to compute the similarity score between the fourth article feature vector 154′ and the third candidate article feature vector 153.

In the article detection phase 210, if the number of corresponding registration points is insufficient, which results in the article detection programming module 310 being unable to determine the transformation matrix Y, the system is configured to directly determine a similarity score of zero and terminate the subsequent execution of the discrepancy determination programming module 330 in the discrepancy determination phase 230.

FIG. 11 is a block based schematic diagram illustrating the deep neural network included in the fourth embodiment according to the present invention. In this embodiment, the deep neural network is used as an example. The article detection programming module 310 is configured to execute a deep neural network. The execution of the deep neural network provides two types of output results: the first output result indicates the degree of match between two images, and the second output result provides the transformation matrix Y if it is found.

The first output result represents the degree of match in a form of y=0˜1, where a value of y of 0 indicates that the third candidate article image 123 and the fourth article image 124 are completely unrelated or unmatched, that is, the third candidate article 113 and the fourth article 114 are different products or items. A value of y of 1 indicates that the third candidate article image 123 and the fourth article image 124 are perfectly matched, and the fourth article 114 is the same as the third candidate article 113.

If the degree of match y is greater than a particular threshold value, for example, but not limited to 0.5, the two images are considered to have reached a certain level of match. At this point, the deep neural network within the article detection programming module 310 is configured to compute the transformation matrix Y and to output it as the second result. If the degree of match y does not exceed the threshold, the system is configured to skip the computation of the transformation matrix Y, directly determine a similarity score of zero, and terminate the subsequent execution of the discrepancy determination programming module 330 in the discrepancy determination phase 230.

After the transformation matrix Y is generated, in the article detection phase 210, the article detection programming module 310 is configured to align and register the fourth article box image 144 contained in the fourth article box 134 with the third candidate article image 123 through the transformation matrix Y, and to generate the aligned fourth article box image 144′.

After the transformation matrix Y is generated, the shared feature detection phase 220 and the discrepancy determination phase 230 are configured to be performed continuously to confirm whether the third candidate article 113 and the fourth article 114 are the same article. In the shared feature detection phase 220, after the shared feature extraction programming module 320 is executed, it is configured to begin extracting the aligned fourth article feature vector 154′ from the aligned fourth article box image 144′. The discrepancy determination phase 230 is then configured to execute the discrepancy determination programming module 330 to compute the similarity score between the aligned fourth article feature vector 154′ and the third candidate article feature vector 153.

To further enhance the capability of the article recognition system and method according to the present invention, and to enable the shared feature extraction programming module 320 to perform effective learning, judgment, and prediction even with a small amount of training data, the invention proposes a fifth embodiment. In this embodiment, the image registration transformation programming unit 350 is selectively integrated into the shared feature extraction programming module 320, and the image registration transformation programming unit 350 is preferably, but not limited to, a domain adversarial neural network (DANN).

In the fifth embodiment, in the preparation phase 240, when the candidate article image database is established, only the original third candidate article image 123 is required to be stored in the database 104, and the candidate article feature vector 109 is not required to be generated or stored.

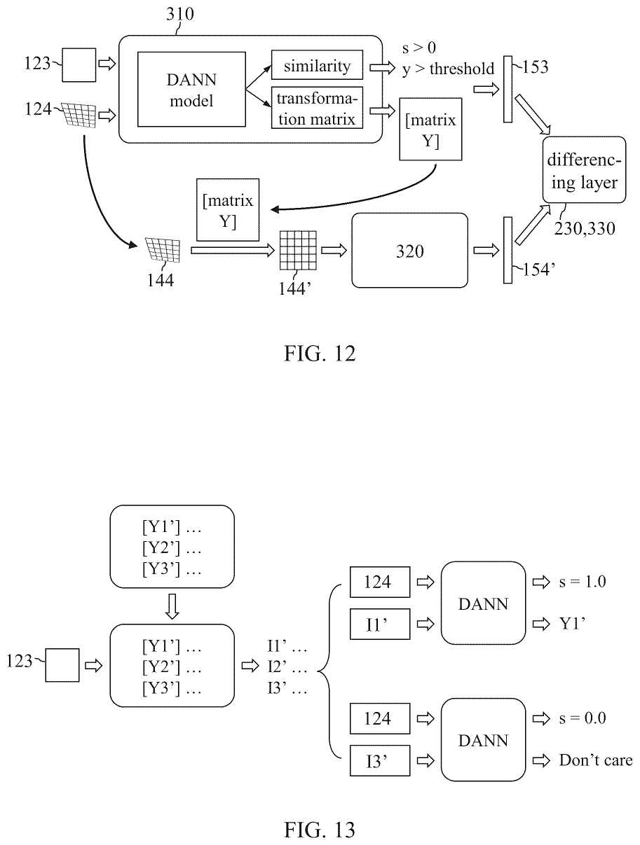

FIG. 12 is a block based schematic diagram illustrating the domain adversarial neural network included in the fifth embodiment according to the present invention. In this embodiment, the article detection programming module 310 is configured to output the fourth article image 124. The shared feature extraction programming module 320 preferably includes a selective domain adversarial neural network model. After the fourth article image 124 is received, the shared feature extraction programming module 320 is configured to provide two types of output results: the first output result is the similarity score s between the fourth article image 124 and the third candidate article image 123, and the second output result is the transformation matrix Y between the fourth article image 124 and the third candidate article image 123, if found.

The first output result represents the similarity score in a form of s=0˜1, where a value of s of 0 indicates that the third candidate article image 123 and the fourth article image 124 are completely different, that is, the third candidate article 113 and the fourth article 114 are different products or items. A value of s of 1 indicates that the third candidate article image 123 and the fourth article image 124 are perfectly matched, and the fourth article 114 is the same as the third candidate article 113.

If the similarity score s is greater than a particular threshold value, for example, but not limited to 0.5, it is considered that the two images have a certain degree of similarity. At this time, the domain adversarial neural network model included in the shared feature extraction programming module 320 is then configured to further compute the transformation matrix Y and output it as the second result. If the similarity score s does not exceed the threshold value, it is not necessary to compute the transformation matrix Y, and the system is configured to directly determine a similarity score of zero and terminate the subsequent execution of the discrepancy determination programming module 330 in the discrepancy determination phase 230.

After the transformation matrix Y is generated, in the shared feature detection phase 220, the shared feature extraction programming module 320 is configured to align the fourth article box image 144 contained in the fourth article box 134 with the third candidate article image 123 through the transformation matrix Y, to generate the aligned fourth article box image 144′, and then to extract the corresponding aligned fourth article feature vector 154′.

After the transformation matrix Y is generated, it is still necessary to perform the discrepancy determination phase 230 to further confirm whether the third candidate article 113 and the fourth article 114 are the same article. In the discrepancy determination phase 230, the discrepancy determination programming module 330 is configured to compute the similarity score between the aligned fourth article feature vector 154′ and the third candidate article feature vector 153.

Preferably, for the domain adversarial neural network model, only a relatively small amount of training data is required to complete the training of the model. Preferably, the domain adversarial neural network model can be fully trained using artificially generated data without the need for a large volume of real image data for training.

FIG. 13 is a block based schematic diagram illustrating the training method for the domain adversarial neural network in the fifth embodiment according to the present invention. For example, it is preferable to randomly generate multiple random transformation matrices including Y1′, Y2′, Y3′, etc. The three random transformation matrices of Y1′, Y2′, and Y3′ are intended to randomly cover various possible image alignment and registration relationships, including but not limited to: translation, rotation, scaling, skewing, projection, affine transformation, and similarity transformation. The third candidate article image 123 is then transformed into three corresponding transformed images of I1′, I2′, and I3′ by the three random transformation matrices Y1′, Y2′, and Y3′ respectively.

Next, two extreme cases are generated for similarity s=1.0, which refers to completely similar, and similarity s=0.0, which refers to completely dissimilar. For the completely similar case where s=1.0, it is assumed that the transformed image I1′ is most similar to the third candidate article image 123, and its corresponding inverse matrix is the random transformation matrix Y1′. For the completely dissimilar case where s=0.0, it is assumed that the transformed image I3′ is completely different from the third candidate article image 123, and its corresponding inverse matrix is the random transformation matrix Y3′. In the case of complete dissimilarity, the system is configured to set the corresponding attribute to “don't care” and the random transformation matrix Y3′ no longer requires to be computed any more. The domain adversarial neural network model is firstly trained using the two extreme cases, and then additional artificially generated data is used to further train the domain adversarial neural network model, which is sufficient to enable the domain adversarial neural network model to learn how to identify the similarity s between different images and generate the corresponding transformation matrix Y.

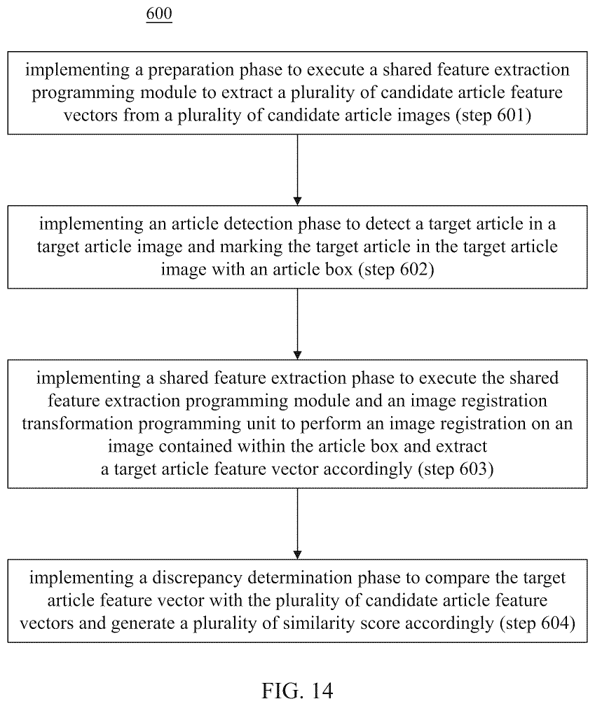

FIG. 14 is a flow chart showing the implementation steps involved in the article recognition method according to the present invention. The article recognition method 600 preferably includes, but is not limited to, the following steps: implementing a preparation phase to execute a shared feature extraction programming module to extract a plurality of candidate article feature vectors from a plurality of candidate article images (step 601); implementing an article detection phase to detect a target article in a target article image and marking the target article in the target article image with an article box (step 602); implementing a shared feature extraction phase to execute the shared feature extraction programming module and an image registration transformation programming unit to perform an image registration on an image contained within the article box and extract a target article feature vector accordingly (step 603); and implementing a discrepancy determination phase to compare the target article feature vector with the plurality of candidate article feature vectors and generate a plurality of similarity score accordingly (step 604).

The article recognition method provided by the present invention is capable of effectively solving the problem of requiring a large number of labels when using article recognition techniques for articles, objects, products and items on sale that change quickly and frequently. Whenever articles are added to or removed from the shelves, it is only necessary to update the images stored in the database and not to retrain the article recognition model. Multiple images representing the same article filmed from different angles of view, can be stored to improve overall recognition accuracy, which provides excellent scalability. Hence, the present method is particularly suitable for applications such as retail, self-checkout, point-of-sale or point-of-service systems.

In practical applications, the article recognition system 100, the article recognition method 200, and the article recognition programming model 300 according to the present invention are not only applicable to fields such as retail, self-checkout, point-of-sale and point-of-service systems, but can also be applied to other fields, including but not limited to: smart shelves, smart warehouses, unmanned stores, smart homes, warehouse logistics, industrial manufacturing and medical fields.

The article recognition system 100, article recognition method 200, and article recognition programming model 300 provided by the present invention, are capable of offering excellent flexibility in dealing with frequently changing on sale products, by separating and splitting apart the article detection process, the feature extraction process, and the discrepancy determination process. It effectively reduces the cost of training and deployment of artificial intelligence models. The hierarchical design according to the present invention greatly improves the flexibility and scalability of the system, making it highly suitable for practical application scenarios where on sale products change frequently.

There are further embodiments provided as follows.

Embodiment 1: An article recognition method, includes: executing a first feature extraction programming module to extract a plurality of candidate article feature vectors from a plurality of candidate article images; executing a second feature extraction programming module and an image registration transformation programming unit to perform an image registration on a target article image and extract a target article feature vector therefrom; and executing a discrepancy determination programming module to compare the target article feature vector with each of the plurality of candidate article feature vectors and generate a similarity score accordingly.

Embodiment 2: The article recognition method according to Embodiment 1 further includes: in a preparation phase, executing the first feature extraction programming module to extract the plurality of candidate article feature vectors from the plurality of candidate article images; in a shared feature extraction phase, executing the second feature extraction programming module and the image registration transformation programming unit to perform the image registration on the target article image and extract the target article feature vector from the registered target article image, wherein the first feature extraction programming module and the second feature extraction programming module share the same plurality of parameters and weights; and in a discrepancy determination phase, executing the discrepancy determination programming module to compare the target article feature vector with each of the plurality of candidate article feature vectors and generate the similarity score accordingly.

Embodiment 3: The article recognition method according to Embodiment 2, the preparation phase further includes one of: acquiring the plurality of candidate article images for a plurality of candidate articles; labeling each of the plurality of candidate article in the plurality of candidate article images with a plurality of rectangular boxes; training an article detection programming module using the labeled candidate article images; executing the first feature extraction programming module to extract the plurality of candidate article feature vectors from a plurality of images contained within the plurality of rectangular boxes; and storing the plurality of candidate article feature vectors in a database.

Embodiment 4: The article recognition method according to Embodiment 3, the preparation phase further includes one of: filming a first candidate article from different angles of view to generate a plurality of first candidate article images from different angles of view; and storing a plurality of first candidate article feature vectors in a database.

Embodiment 5: The article recognition method according to Embodiment 4, further includes: determining a target article contained in the target article image as the first candidate article when the similarity score exceeds a threshold value, wherein the threshold value is 0.95, 0.96, 0.97, 0.98, or 0.99.

Embodiment 6: The article recognition method according to Embodiment 1, the first feature extraction programming module and the second feature extraction programming module are a shared feature extraction programming module.

Embodiment 7: An article recognition method, includes: implementing a preparation phase to execute a shared feature extraction programming module to extract a plurality of candidate article feature vectors from a plurality of candidate article images; implementing an article detection phase to detect a target article in a target article image and marking the target article in the target article image with an article box; implementing a shared feature extraction phase to execute the shared feature extraction programming module and an image registration transformation programming unit to perform an image registration on an image contained within the article box and extract a target article feature vector accordingly; and implementing a discrepancy determination phase to compare the target article feature vector with the plurality of candidate article feature vectors and generate a plurality of similarity score accordingly.

Embodiment 8: An article recognition system, includes: a database configured to store a plurality of candidate article feature vectors extracted by executing a first feature extraction programming module; an image sensor configured to capture a target article image for a target article; and a server configured to implement an article recognition method, the article recognition method including: executing an article detection programming module to detect the target article in the target article image and marking the target article in the target article image with an article box; executing a second feature extraction programming module and an image registration transformation programming unit to perform an image registration on an image contained within the article box and extract a target article feature vector accordingly; and executing a discrepancy determination programming module to compare the target article feature vector with the plurality of candidate article feature vectors and generate a similarity score accordingly.

Embodiment 9: The article recognition system according to Embodiment 8, further includes: a checkout management device, wherein the image sensor is attached to the checkout management device, wherein the checkout management device is a self-service terminal, a self-checkout machine, a point-of-sale machine, a point-of-service machine, or a cash register.

Embodiment 10: The article recognition system according to Embodiment 8, the article recognition method further includes a preparation phase, and the preparation phase further includes one of: pre-capturing a plurality of candidate article images for a plurality of candidate articles; labeling each of the plurality of candidate articles in the plurality of candidate article images with a plurality of rectangular boxes; training the article detection programming module using the plurality of labeled candidate article images; executing the first feature extraction programming module to extract the plurality of candidate article feature vectors from a plurality of images contained within the rectangular boxes; and storing the plurality of candidate article feature vectors in the database.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. An article recognition method, comprising:
executing a first feature extraction programming module to extract a plurality of candidate article feature vectors from a plurality of candidate article images;
executing a second feature extraction programming module and an image registration transformation programming unit to perform an image registration on a target article image and extract a target article feature vector therefrom; and
executing a discrepancy determination programming module to compare the target article feature vector with each of the plurality of candidate article feature vectors and generate a similarity score accordingly.

2. The article recognition method according to claim 1, further comprising:
in a preparation phase, executing the first feature extraction programming module to extract the plurality of candidate article feature vectors from the plurality of candidate article images;
in a shared feature extraction phase, executing the second feature extraction programming module and the image registration transformation programming unit to perform the image registration on the target article image and extract the target article feature vector from the registered target article image, wherein the first feature extraction programming module and the second feature extraction programming module share the same plurality of parameters and weights; and
in a discrepancy determination phase, executing the discrepancy determination programming module to compare the target article feature vector with each of the plurality of candidate article feature vectors and generate the similarity score accordingly.

3. The article recognition method according to claim 2, wherein the preparation phase further comprises one of:
acquiring the plurality of candidate article images for a plurality of candidate articles;
labeling each of the plurality of candidate article in the plurality of candidate article images with a plurality of rectangular boxes;
training an article detection programming module using the labeled candidate article images;
executing the first feature extraction programming module to extract the plurality of candidate article feature vectors from a plurality of images contained within the plurality of rectangular boxes; and
storing the plurality of candidate article feature vectors in a database.

4. The article recognition method according to claim 3, wherein the preparation phase further comprises one of:
filming a first candidate article from different angles of view to generate a plurality of first candidate article images from different angles of view; and
storing a plurality of first candidate article feature vectors in a database.

5. The article recognition method according to claim 4, further comprising:
determining a target article contained in the target article image as the first candidate article when the similarity score exceeds a threshold value,
wherein the threshold value is 0.95, 0.96, 0.97, 0.98, or 0.99.

6. The article recognition method according to claim 1, wherein the first feature extraction programming module and the second feature extraction programming module are a shared feature extraction programming module.

7. An article recognition method, comprising:
implementing a preparation phase to execute a shared feature extraction programming module to extract a plurality of candidate article feature vectors from a plurality of candidate article images;
implementing an article detection phase to detect a target article in a target article image and marking the target article in the target article image with an article box;
implementing a shared feature extraction phase to execute the shared feature extraction programming module and an image registration transformation programming unit to perform an image registration on an image contained within the article box and extract a target article feature vector accordingly; and
implementing a discrepancy determination phase to compare the target article feature vector with the plurality of candidate article feature vectors and generate a plurality of similarity score accordingly.

8. An article recognition system, comprising:
a database configured to store a plurality of candidate article feature vectors extracted by executing a first feature extraction programming module;
an image sensor configured to capture a target article image for a target article; and
a server configured to implement an article recognition method, the article recognition method comprising:
executing an article detection programming module to detect the target article in the target article image and marking the target article in the target article image with an article box;
executing a second feature extraction programming module and an image registration transformation programming unit to perform an image registration on an image contained within the article box and extract a target article feature vector accordingly; and
executing a discrepancy determination programming module to compare the target article feature vector with the plurality of candidate article feature vectors and generate a similarity score accordingly.

9. The article recognition system according to claim 8, further comprising:
a checkout management device, wherein the image sensor is attached to the checkout management device,
wherein the checkout management device is a self-service terminal, a self-checkout machine, a point-of-sale machine, a point-of-service machine, or a cash register.

10. The article recognition system according to claim 8, wherein the article recognition method further comprises a preparation phase, and the preparation phase further comprises one of:
pre-capturing a plurality of candidate article images for a plurality of candidate articles;
labeling each of the plurality of candidate articles in the plurality of candidate article images with a plurality of rectangular boxes;
training the article detection programming module using the plurality of labeled candidate article images;
executing the first feature extraction programming module to extract the plurality of candidate article feature vectors from a plurality of images contained within the rectangular boxes; and
storing the plurality of candidate article feature vectors in the database.
